(19) United States
(12) Patent Application Publication
(10) Pub. No.: US 2011/0100374 A1
(43) Pub. Date: May 5, 2011

(54) Limb supporting apparatus

(76) Inventor: Kris Silfverskiold, Goodwood (AU)

(21) Appl. No.: 12/925,204

(22) Filed: Oct. 15, 2010

(30) Foreign Application Priority Data
Nov. 7, 2008 (AU) 2008905768
Oct. 28, 2009 (AU) PCT/AU2009/001411

(51) Int. Cl. A61G 15/00

(52) U.S. Cl. 128/845

(57) ABSTRACT

The present invention relates to an arm protection apparatus, and particularly an apparatus for protecting an arm from pressure injury. The apparatus comprises a pliant material having receiving portions for the upper arm and lower arm and releasable straps for the upper and lower arm. Wherein, in use, the channel and straps surround the arm so as to distribute pressure on the arm and reduce the likelihood of pressure injury.

### CROSS-REFERENCE TO RELATED APPLICATION

This application claims priority to Australian Patent Application No. 2008905768 filed Nov. 7, 2008. The entire contents of this application is hereby incorporated by reference.

### FIELD OF THE INVENTION

The present invention relates to an arm protection apparatus and in particular to an apparatus for protecting an arm from pressure injury.

### BACKGROUND OF THE INVENTION

In an active person, limbs can overcome poor positioning, excessive pressure and traction by reflexive withdrawal and repositioning of the affected limb. However, under anaesthetic or during emergency transport, patients have little or no control over the position of their limbs and thus rely on correct placement of such limbs by attending medical professionals. In a busy environment such as the operating theatre, limbs, in particular the arm, can be sited or can be moved to positions likely to cause damage to the limb. Such damage may include injury due to excessive pressure on immobilized tissue.

Excessive pressure in an anaesthetized patient can result in pain, swelling and blistering. In serious cases where pressure is maintained for an extensive time, such pressure can result in deep ulcers and irretrievable tissue loss. In addition, the limbs can, if left under constant pressure for extended periods of time, suffer pressure injuries to major nerve trunks. In the case of the arm, the ulnar nerve is particularly vulnerable to pressure due to an exposed position along the inside of the elbow. The result of such a nerve injury can be loss of feeling and/or permanent loss of motor function in the hand.

To gain access to limbs for intravenous drips and for various monitoring purposes during medical procedures, limbs are often positioned and/or restrained on a rigid arm board connected to an operating table. To prevent pressure injuries, the arm board is usually fitted with padding placed between the arm and the board. To secure the limb on the board, the limb is restrained by strapping, taping or bandaging the limb to the board. It is common for the limbs to be covered during operating procedures. Therefore, inadvertent movements of the limb, displacing the limb on or off the board, are not readily detectable.

Displacement of a limb can potentially occur if attending staff accidentally collide with the board or because of sudden movements by an anaesthetized patient. Current methods to hold the limb in position on the rigid arm board, such as straps, are insufficient to restrict transverse forces and reliably prevent such displacement of the limb. If the limb is displaced, the edges of restraints (e.g. straps) may themselves cause injury by providing excessive localized pressure. Other methods, such as wide circumferential bandaging around the limb and the rigid board, may afford some limited added security but also prevent visual and/or manual access to the arm. For example, intravenous lines may not remain visible under the strapping and once the limb has been strapped, it can be difficult to access the limb so as to access veins.

In an environment such as an operating theatre, it is common during the use of a general anaesthetic or intravenous sedation to have multiple lines attached to a limb. It is conventional to have at least one intravenous line, one pulse oximetry lead and a set of blood pressure cuff tubes exit the area of the rigid arm board at potentially three different locations along the limb before crossing over to the anaesthetic machine or other devices. The space between the patient and these devices is often used for attending staff and therefore multiple leads pose a risk of being tripped over or dislodged by such staff. If the limb is covered by drapes, which is not unusual, the dislodgement of such leads may not be detected immediately. It would be beneficial to collate and protect multiple lines or leads alongside the limb or provide pre-determined collective exit points along a limb to minimise the number of separate lines or leads leading from the rigid arm board and transversing the space between the patient and medical equipment.

During emergency transport of ill or sick persons and during transport of persons having injured arms, there is a need for protecting and/or splinting the arms. Although there are a multitude of products used to address this need, collectively they have shortcomings. It is an object of the present invention to provide an apparatus that overcomes or at least ameliorates some or all of the aforementioned problems.

### SUMMARY OF THE INVENTION

According to a first aspect of the invention, there is provided an arm protection apparatus for protecting an arm, the apparatus including: a channel formed from a pliant material and defining an upwardly opening mouth for receiving the arm, the channel having an upper arm receiving portion and a lower arm receiving portion; an upper arm strap having a first end connected to a first side of the upper arm receiving portion and a second end adapted for releasable engagement with a second side of the upper arm receiving portion; a lower arm strap having a first end connected to a first side of the lower arm receiving portion and a second end adapted for releasable engagement with a second side of the lower arm receiving portion, wherein, in use, the channel and the straps encircle the arm and the apparatus distributes pressure on immobilized tissue of the arm so as to reduce the likelihood of pressure injury. In one form the upper and lower arm receiving portions are partially separated by an upwardly opening lateral slot. In one form the apparatus includes a means for attaching the channel to an arm board of an operating table.

In one form the pliant material is a single folded foam sheet including: an elongate central base portion having a longitudinal axis, the base portion bounded by first and second fold zones extending generally parallel to the longitudinal axis; a first side portion extending outwards from the first fold zone; and a second side portion extending outwards from the second fold zone, whereby the first and second fold zones reduce the tendency of the first and second side portions to unfold.

According to a second aspect of the invention, there is provided an arm protection apparatus for protecting a arm, the apparatus including: a channel formed from a pliant material and defining an upwardly opening mouth for receiving the arm, the channel having an upper arm receiving portion and a lower arm receiving portion; an upper arm strap having a first end connected to a first side of the upper arm receiving portion and a second end adapted for releasable engagement with a second side of the upper arm receiving portion; a lower arm strap having a first end connected to a first side of the lower arm receiving portion and a second end adapted for releasable engagement with a second side of the lower arm receiving portion, wherein the pliant material is a single folded foam sheet including: an elongate central base portion having a longitudinal axis, the base portion bounded by first and second fold zones extending generally parallel to the longitudinal axis; a first side portion extending outwards from the first fold zone; and a second side portion extending outwards from the second fold zone, whereby the first and second fold zones reduce the tendency of the first and second side portions to unfold.

In one form the apparatus further includes: a first securing strap for securing the channel to an arm board, the first securing strap having a first end connected to the second side of the upper arm receiving portion and a second end adapted for releasable engagement with the first side of the upper arm receiving portion; and a second securing strap for securing the channel to an arm board, the second securing strap having a first end connected to the second side of the lower arm receiving portion and a second end adapted for releasable engagement with the first side of the lower arm receiving portion. In one form the first end of the upper arm strap and the first end of the first securing strap are positioned opposite each other such that, when securing the channel to the arm board, the second end of the first securing strap releasably engages the upper arm strap at or near the upper arms strap's first end.

According to a third aspect of the invention, there is provided a foam sheet foldable to form an arm protection apparatus, the sheet including: an elongate central base portion having a longitudinal axis, the base portion bounded by first and second fold zones extending generally parallel to the longitudinal axis; a first side portion extending outwards from the first fold zone; and a second side portion extending outwards from the second fold zone, wherein the first and second fold zones facilitate folding upwards of the first and second side portions so as to form a channel for receiving and protecting an arm. In one form the first and second fold zones are formed by a plurality of holes arranged in respective first and second lines. In one form the first side portion includes an upper arm engaging portion and a lower arm engaging portion, the upper and lower arm engaging portions partially separated by a laterally opening slot.

According to a fourth aspect of the invention, there is provided an arm protection apparatus for protecting an arm, the apparatus including: a channel formed from a pliant material and defining an upwardly opening mouth above a base for receiving the arm, the channel having an upper arm receiving portion and a lower arm receiving portion; an upper arm strap having a first end connected to a first side of the upper arm receiving portion and a second end adapted for releasable engagement with a second side of the upper arm receiving portion; a lower arm strap having a first end connected to a first side of the lower arm receiving portion and a second end adapted for releasable engagement with a second side of the lower arm receiving portion; a spine under the base of the channel, the spine having a hinge between the upper arm receiving portion and the lower arm receiving portion, wherein, in use, the channel and the straps encircle the arm and the apparatus distributes pressure on immobilized tissue of the arm so as to reduce the likelihood of pressure injury. In one form the spine includes a lock, the lock movable between an unlocked position in which the channel is foldable about a fold axis between the upper arm receiving portion and the lower arm receiving portion and an locked position in which the channel is locked against folding about a fold axis between the upper arm receiving portion and the lower arm receiving portion. In one form the lock includes a sleeve, the sleeve slidable over the hinge so as to prevent operation of the hinge.

According to a fifth aspect of the invention, there is provided an arm protection apparatus for protecting an arm, the apparatus including: a channel formed from a pliant material and defining an upwardly opening mouth for receiving the arm, the channel having an upper arm receiving portion and a lower arm receiving portion; an upper arm strap including an underlap portion extending from a first side of the upper arm receiving portion and an overlap portion extending from a second side of the upper arm receiving portion, the underlap and overlap portions having ends adapted for releasable engagement with each other; an lower arm strap including an underlap portion extending from a first side of the lower arm receiving portion and an overlap portion extending from a second side of the lower arm receiving portion, the underlap and overlap portions having ends adapted for releasable engagement with each other, wherein, in use, the channel and the straps encircle the arm and the apparatus distributes pressure on immobilized tissue of the arm so as to reduce the likelihood of pressure injury.

According to a sixth aspect of the invention, there is provided a method of protecting and restraining an arm during a medical procedure, the method including the steps of: positioning the patient on an operating table; positioning an arm of the patient into an arm protecting apparatus, the apparatus partly-encircling the arm along a substantial length of both a forearm portion of the arm and a humeral portion of the arm; securing the forearm and upper arm portions using at least two straps, each strap bridging walls of the limb support apparatus so as to encircle the arm; whereby the arm is restrained from substantial movement during the procedure and is protected from lateral impacts.

According to a seventh aspect of the invention, there is provided a method of protecting and restraining an arm during a medical procedure, the method including the steps of: positioning the patient on an operating table; positioning an arm of the patient into an arm protecting apparatus having an upwardly opening slot within a side wall of the apparatus for allowing easy access to the arm, the apparatus partly-encircling the arm along a substantial length of both a forearm portion of the arm and a humeral portion of the arm; securing the forearm and upper arm portions using at least two straps, each strap bridging walls of the limb support apparatus so as to encircle the arm; whereby the arm is restrained from substantial movement during the procedure and is protected from lateral impacts.

According to a eighth aspect of the invention, there is provided a method of protecting and restraining an arm during a medical procedure using the apparatus of claim 5, the method including the steps of: positioning the apparatus onto an arm board of an operating table; arranging the first strap so that it extends from the second side of the upper arm receiving portion, under the arm board and up to the upper arm strap; adhering the second end of the first securing strap to the upper arm strap; arranging the second strap so that it extends from the second side of the lower arm receiving portion, under the arm board and up to the lower arm strap; adhering the second end of the second securing strap to the lower arm strap; positioning the patient on an operating table; positioning an arm of the patient into the channel of the apparatus; looping the upper arm strap from the first side of the upper arm receiving portion over the arm to the second side of the upper arm receiving portion; adhering the second end of the upper arm strap to the first end of the first securing strap; looping the lower arm strap from the first side of the lower arm receiving portion over the arm to the second side of the lower arm receiving portion; adhering the second end of the lower arm strap to the first end of the second securing strap, whereby the arm is restrained from substantial movement during the procedure and is protected from lateral impacts.

Specific embodiments of the invention will now be described in some further detail with reference to and as illustrated in the accompanying figures. These embodiments are illustrative, and are not meant to be restrictive of the scope of the invention.

### BRIEF DESCRIPTION OF THE DRAWINGS

An illustrative embodiment of the present invention will be discussed with reference to the accompanying drawings wherein:

FIG. 1a is an illustration of the background art showing an example of the positioning of an arm during surgery;

FIG. 1b is a further illustration of the background art showing an example of the positioning of an arm during surgery;

FIG. 2a is an isometric view of an arm protection apparatus according to a first embodiment of the invention;

FIG. 2b is an isometric view of an arm protection apparatus according to a second embodiment of the invention;

FIG. 3a is a plan view of a foam sheet formable to form the channel of either one of the embodiments of the invention illustrated in FIGS. 2a and 2b;

FIG. 3b is a similar view of the foam sheet of FIG. 3a but without lateral slots;

FIG. 4 is an isometric view of a third embodiment of the invention;

FIGS. 5a, 5b, 5c, 5d, 5e and 5f are diagrammatic end views showing the third embodiment of FIG. 4 being progressively used;

FIG. 6 is an isometric view of a fourth embodiment of the invention;

FIGS. 7a, 7b and 7c are diagrammatic views of a portion of the apparatus of FIG. 6 showing operation of its hinge and lock;

FIG. 8 is a plan view of a fifth embodiment of the invention, protecting and supporting an arm, the apparatus supported on an arm board;

FIG. 9 is a similar view to that of FIG. 8, but shows the apparatus alongside a patient's body on an operating table.

FIG. 10 is an isometric view of a sixth embodiment of the invention;

FIGS. 11a and 11b are diagrammatic end views showing different alternative configurations of the channel of the various embodiments of the invention;

FIGS. 12a, 12b and 12c are end side and underside views respectively of the sixth embodiment of the invention shown in FIG. 10;

FIG. 13 is an exploded isometric view showing the sixth embodiment of the invention of FIGS. 10, 12a, 12b and 12c above an arm board;

FIG. 14 is an underside isometric view showing a seventh embodiment of the invention having an inflatable element on its base;

FIGS. 15 and 16 are isometric views showing an eighth embodiment of the invention having an integral pressure cuff.

FIGS. 17 and 18 are isometric and part plan views respectively of a ninth embodiment of the invention.

FIG. 19 is an isometric view of a tenth embodiment of the invention.

### DESCRIPTION OF ILLUSTRATIVE EMBODIMENT

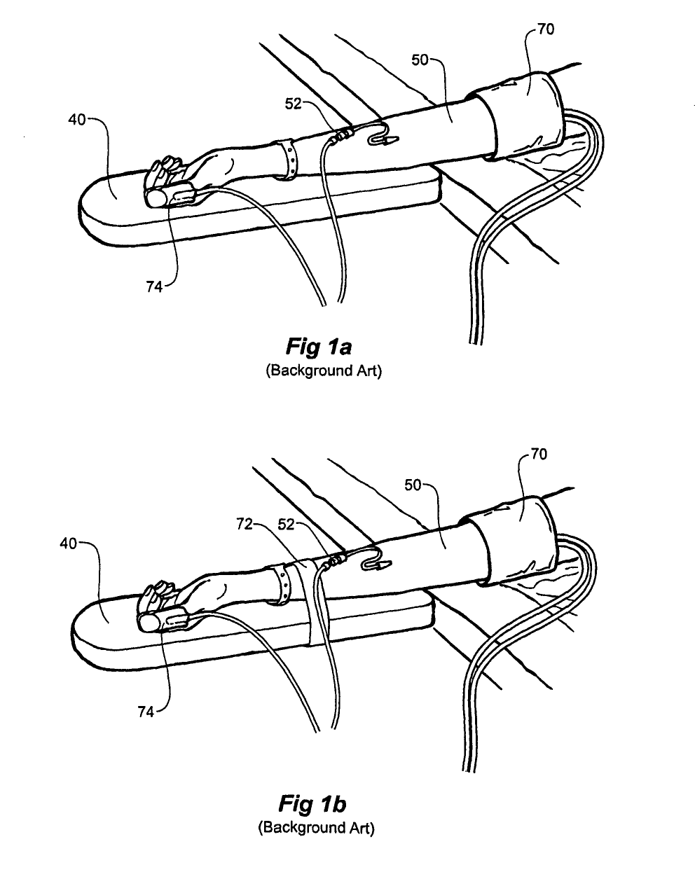

Referring to FIGS. 1a and 1b, there is shown illustrations of the background art showing examples of the positioning of an arm 50 during surgery. In both examples, the arm 50 is supported by a rigid arm board 40 at an angle to both the patient's body and the operating table. In FIG. 1a it is clear that the arm 50 is not restrained but simply placed on the rigid arm board 40. With this arrangement, the arm is susceptible to unexpected transverse forces such as an inadvertent collision with operating room staff. In addition, sudden unexpected movements from an anaesthetized patient may cause the arm 50 to fall off the arm board 40, potentially causing damage to the arm 50. FIG. 1b shows a typical manner in which the arm 50 may be restrained to prevent it from falling off a rigid arm board 40. The arm 50 is restrained on the adjacent arm 40 board via a single narrow strap 72. As such sudden movements of the arm 50 can place undue pressure between single strap 72 and the patient's arm and may cause pressure injury to the arm.

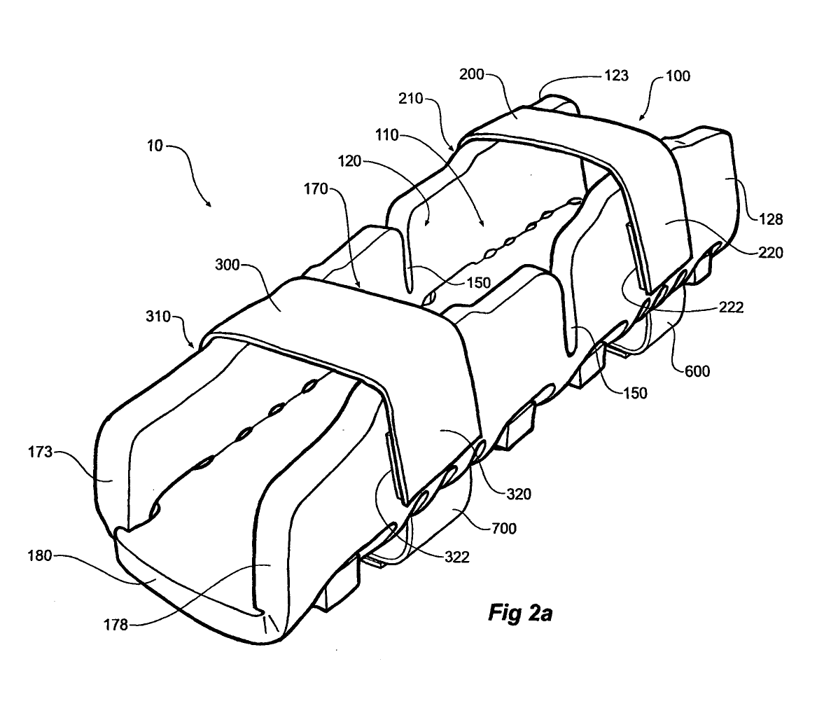

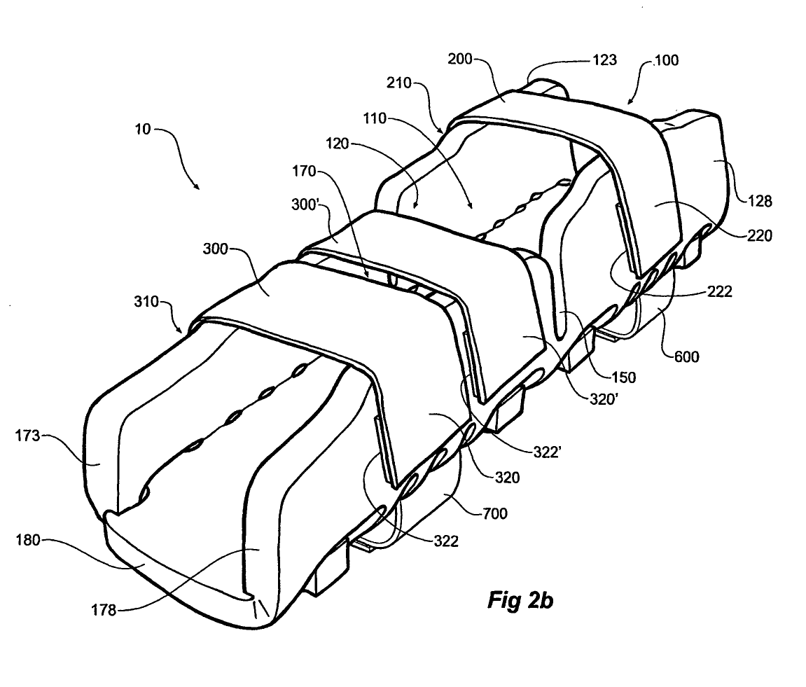

Referring to FIG. 2a, an arm protection apparatus 10 according to the invention is shown. The arm protection apparatus 10 includes a channel 100 formed from a pliant material such as urethane foam and defining an upwardly opening mouth 110 for receiving an arm 50. For instance, it may receive an arm 50 of a patient during surgery. The channel 100 has an upper arm receiving portion 120 and a lower arm receiving portion 170. The upper and lower arm receiving portions 120 and 170 are partially separated by two upwardly opening lateral slots 150. The apparatus 10 also includes an upper arm strap 200 and a lower arm strap 300. In use, the channel 100 and the straps 200 and 300 encircle the arm and the apparatus 10 distributes pressure on immobilized tissue of the arm so as to reduce the likelihood of pressure injury.

The upper arm strap 200 has a first end 210 connected to a first side of the upper arm receiving portion 120 and a second end 220 adapted for releasable engagement with the second side of the upper arm receiving portion 120. With the embodiment illustrated, releasable engagement is provided by a hook and loop fastener (such as Velcro®). The hook and loop fastener comprises a Velcro hook pad 225 on the end 220 of the upper arm strap 200 and a Velcro hook receiver (loop pad 222). In the embodiment shown in FIG. 2a the straps 200 and 300 are glued onto the sides of the channel 100. In other embodiments they may be connected by other means, including by being integral with the material from which the channel is formed.

Referring again to FIG. 2a, a first securing strap 600 and a second securing strap 700 are provided to attach the apparatus 10 to an arm board of the type shown in FIGS. 1a and 1b for instance.

FIG. 2b shows an arm protection apparatus according to a second embodiment of the invention. This embodiment of the invention is very similar to that shown in FIG. 2a, but a second lower arm strap 300′ is provided.

With both of the embodiments of the invention shown in FIGS. 2a and 2b, a single sheet of foam is folded to provide the channel 100. In other embodiments of the invention, to be described later, multiple pieces of foam may be used and glued together (for instance see the embodiment of the invention illustrated in FIG. 10).

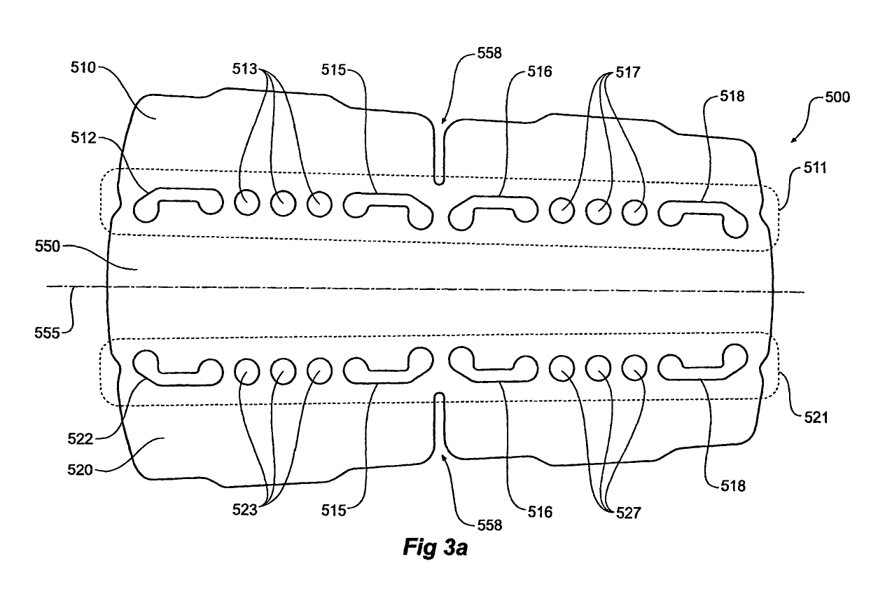

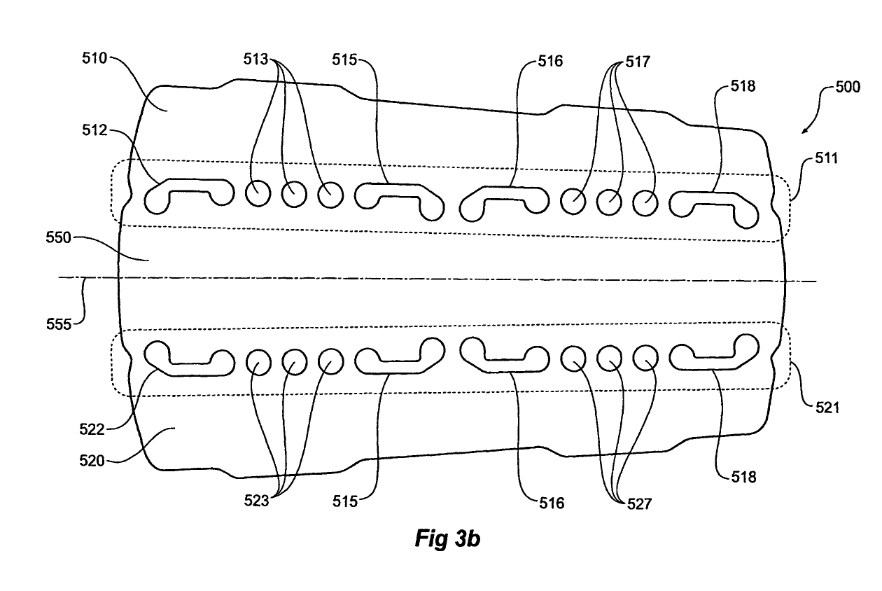

A further embodiment of the invention in the form of a foam sheet is shown in FIGS. 3a and 3b. With these embodiments of the invention, a single unitary sheet of foam that is foldable to form an arm protection apparatus is provided. With the embodiment shown in FIG. 3a, an elongate central base portion 550 having a longitudinal axis 555 is bounded by first and second fold zones 511 and 521. The fold zones 511 and 521 are formed by apertures. These apertures are readily created by punching projections through the foam blank. The apertures of the embodiment illustrated in FIG. 3a include simple cylinders 513, 517, 523 and 527 and more complex shaped apertures 512, 515, 516, 518, 522, 525, 526 and 528. The more complex shaped apertures are provided to even further facilitate folding at strategic locations, those strategic locations being the ends and areas adjacent the laterally opening slots 558 and 559. In the embodiment shown, the holes are through holes, in other embodiments, the holes may be blind holes.

The fold zones 511 and 521 extend generally parallel to the longitudinal axis 555. In practice, the fold zones 511 and 521 may be divergent (or convergent) so as to provide an arm protection apparatus wherein the upper arm receiving portion has a wider base that the lower arm receiving portion.

In other embodiments of the invention, not shown, the fold zones may comprise a localized thinning of the foam or other weakening of the foam. In another alternative, grooves may be provided.

Turning now to FIG. 3b, a foam sheet similar to that shown in FIG. 3a is illustrated. With the foam sheet of FIG. 3b, no lateral slots are provided. The foam sheet of FIG. 3b may be used to produce an arm protection apparatus that does not have lateral slots (not illustrated).

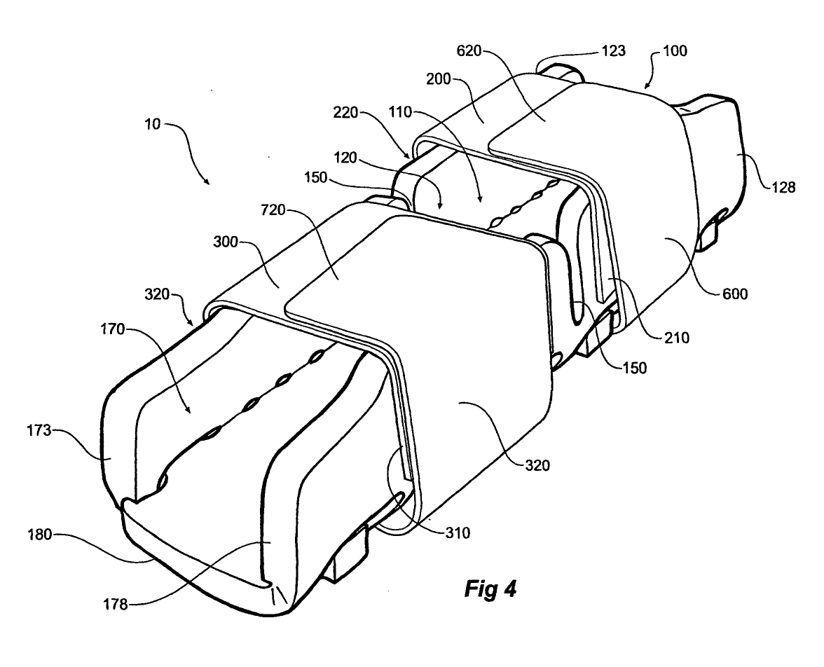

FIG. 4 shows a third embodiment of the invention, that is folded from the foam sheet of FIG. 3a. With the embodiment of the invention shown in FIG. 4, there is overlap between the securing straps 600 and 700 and the upper and lower arm straps 200 and 300.

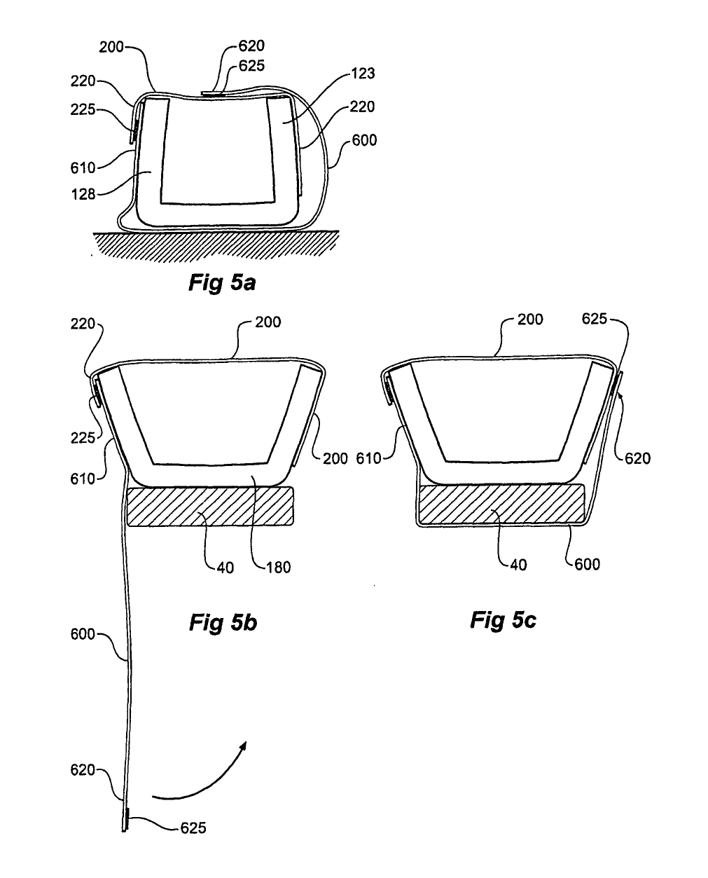

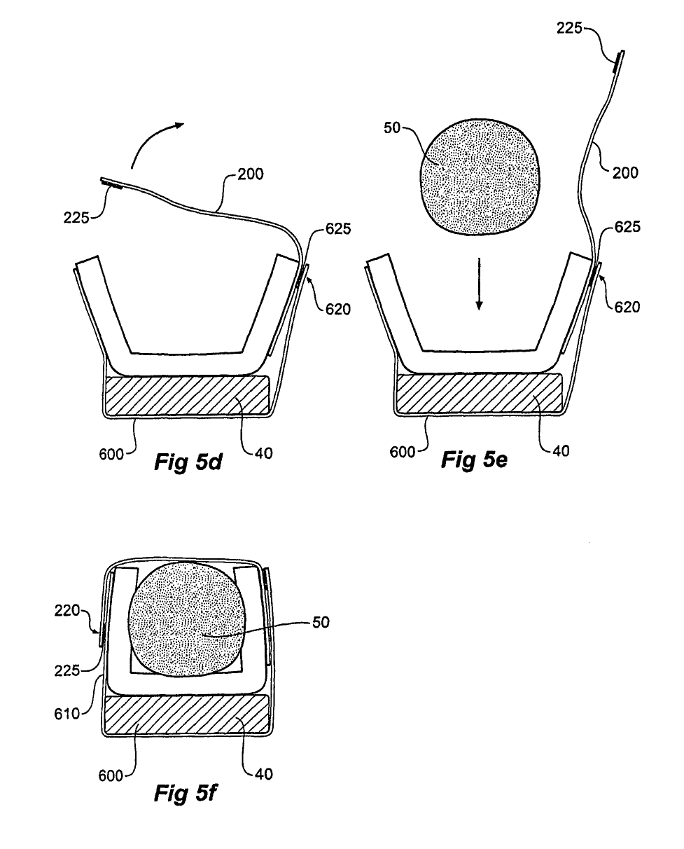

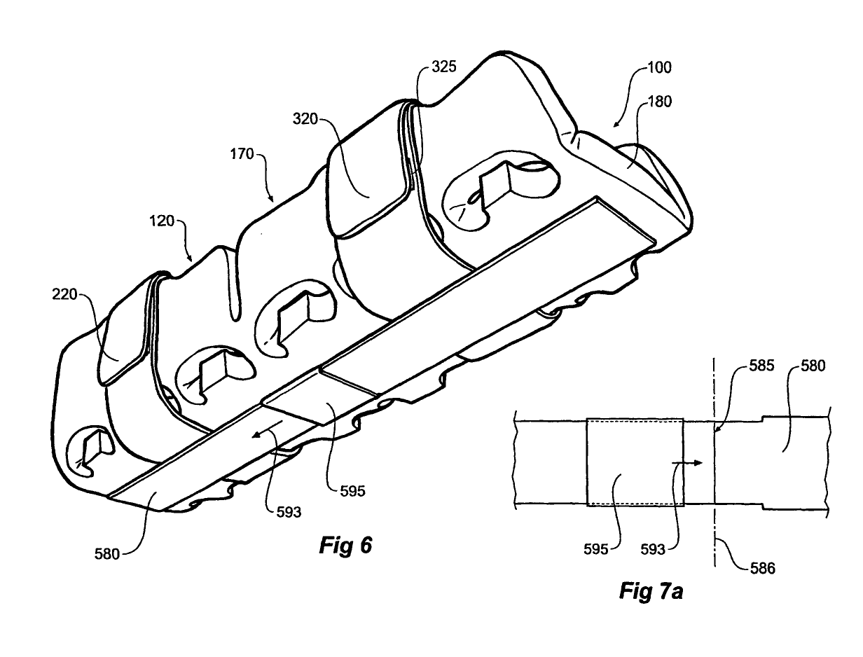

The arm protection apparatus of FIG. 4 has a channel 100 formed from the pliant foam of FIG. 3a which defines an upwardly opening mouth for receiving an arm. In this respect, the third embodiment illustrated in FIG. 4 is the same as the first embodiment of the invention illustrated in FIG. 2a. A first securing strap 600 for securing the channel 100 to an arm board 40 is provided. The first securing strap 600 has a first end 610 (more clearly shown in FIG. 5a) that is connected to a second side 128 of the upper arm receiving portion 120. The first securing strap 600 also has a second end 620 that is adapted for releasable engagement with the upper arm strap 200. In the embodiment illustrated, the adaption takes the form of a Velcro pad 625 comprising a plurality of small plastic hooks is provided on the second end 620 of the first securing strap 600 to provide the aforesaid releasable engagement. In other embodiments of the invention, not shown, other releasable engagement means may be provided. The fact that the Velcro pad 625 of the securing strap 600 engages the upper arm strap 200 eliminates the need for a separate pad to receive the Velcro®.

Similarly, the lower arm strap 300 has a first end 310 connected to a first side 173 of the lower arm receiving portion 170 and a second end 320 adapted for releasable engagement with a second side of the lower arm receiving portion 170.

An advantage of the embodiment of the invention illustrated in FIG. 4 is that the securement straps 600 and 700 can be made long. This is because their ends 620 and 720 attach anywhere along the corresponding upper and lower arm straps 200 and 300. The length of the securing straps it enables the arm protection apparatus to be used with arm boards of varying thicknesses and sizes. The apparatus can also be used in pairs without an arm board by connecting them to each other using additional separate straps (not shown). For instance, one arm protection apparatus may be used on a patient's left arm and another may be used on a patient's right arm. The left and right apparatuses can then be joined using the additional separate straps extending across the patient's back or across the patient's front, depending on whether the patient is in the prone or supine position.

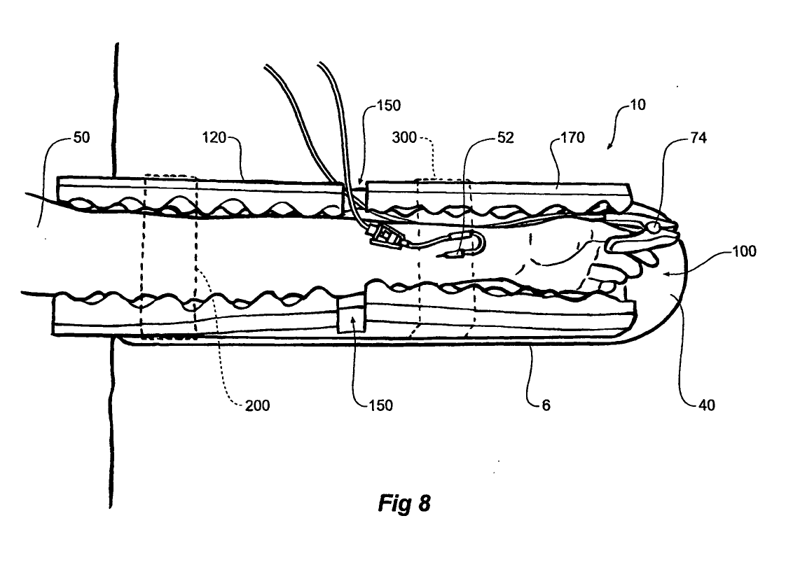

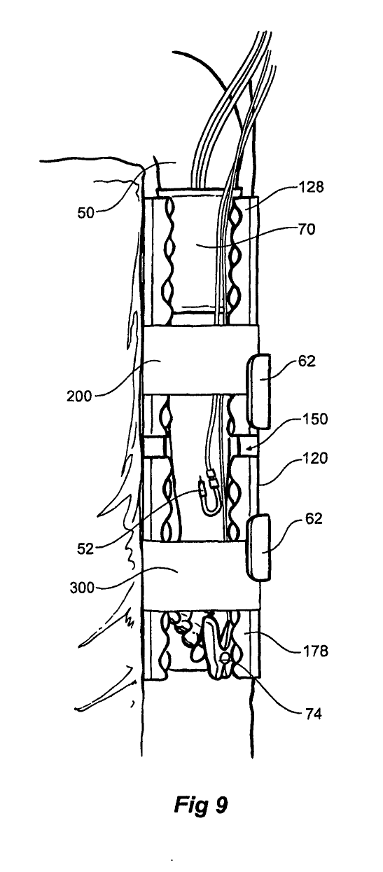

With the embodiments of the invention described so far, with the exception of that illustrated in FIG. 3b, upwardly opening lateral slots 150 are provided. In an environment such as an operating theatre, it is common during the use of a general anaesthetic or intravenous sedation to have multiple lines attached to a limb. As is clearly shown in both FIGS. 1a and 1b, intravenous lines 52 and leads from medical devices such as the blood pressure cuff 70 and pulse oximeter 74 are able to freely fall from wherever they are connected on the arm 50 before crossing over to the anaesthetic machine or other devices. These multiple leads pose a risk of being tripped over or dislodged in other ways by operating theatre staff. In contrast, with the apparatus of the invention, for example as shown in FIG. 8, the intravenous line 52, the pulse oximetery lead 74 and the blood pressure cuff 70 are arranged within a semi-encircling channel 100 such that each lead exits at a single point in the apparatus, in this case the proximal end. It is also possible for the leads to exit the apparatus at the distal end of the apparatus or via the medially-located slots 150 within the walls of the apparatus. This reduces the risk of leads being tripped over or dislodged.

The location of slots 150 in the midsection of the channel 100 also enables the apparatus to be folded with the line defined by the slots acting as a hinge joint. In alternate embodiments, the channel 100 may comprise a single upwardly opening slot located in one side wall or the channel may comprise multiple slots located in one or both of the side walls. The slots may be located in regions other than the midsection of the side wall.

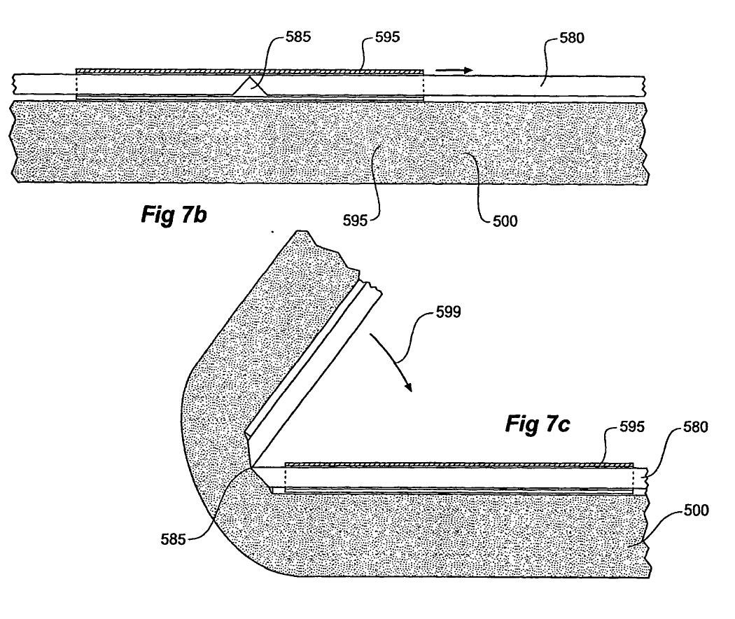

A fourth embodiment of the invention is shown in FIGS. 6, 7a, 7b and 7c. With this embodiment, a channel 100 is again formed from the foam sheet of FIG. 3a. The channel 100 defines an upwardly opening mouth above a base 180 for receiving an arm. The channel 100 has an upper arm receiving portion 120 and a lower arm receiving portion 170. An upper arm strap 200 having a first end 210 connected to a first side of the upper arm receiving portion 120 and a second end 220 adapted for releasable engagement with a second side of the upper arm receiving portion 120 is also provided. Similarly, a lower arm strap 300 is also provided. In this respect, this embodiment of the invention is quite similar to the other embodiments described above. However, with this embodiment of the invention, a spine 580 under the base 180 of the channel 100 is provided. The spine 580 has a hinge 585 between the upper arm receiving portion 120 and the lower arm receiving portion 170. This embodiment of the invention is particularly suitable for field use. For instance, this embodiment of the invention can be used to protect an arm during transport of a patient from an accident scene to a hospital. Again, the channel 100 and the straps 200 and 300 encircle the arm to reduce the likelihood of pressure injury to the arm during transport. The hinge 585 most clearly shown in FIGS. 7b and 7c allow the apparatus to be folded. This, combined with the fact that the foam material from which the channel 100 is formed is compressible, allows the entire apparatus to be vacuum packed into a very compact and easily transported pack.

The spine 580 is preferably made from a suitable plastic that allows the hinge 585 to be part of the actual spine rather than separate components. That is, the hinge 585 is formed simply by a local line of weakening. A lock is provided by a slidable sleeve 595. This sleeve may be made from aluminium or any other suitable material. FIG. 7a shows the hinge 585 before it is locked. The sleeve 595 is slid in the direction of arrow 593 in order to lock the spine 580 into the position shown in FIG. 6.

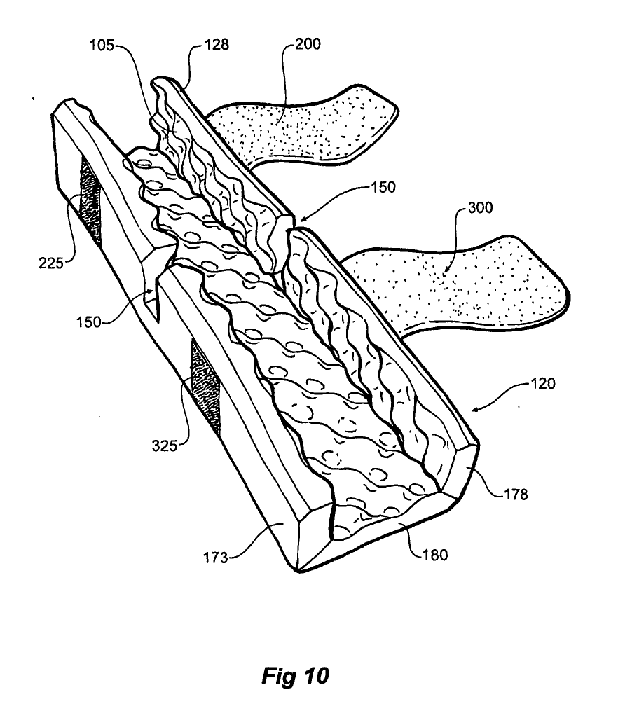

FIG. 8 shows an arm protection apparatus 10 according to the invention on a rigid board 40. In this embodiment, the arm is restrained in the limb supporting apparatus 10 on the rigid arm board 40 located at angles to both the patient's body and the operating table. In comparison, FIG. 9 shows the positioning of the arm 50 when used with the apparatus 10 without the need for the rigid arm board. Instead the arm is secured in the apparatus 10 adjacent to the patient's body and on the operating table. It is possible for the apparatus 10 to be restrained on the operating table by rigid lateral supports 62 which place pressure on the wall 128 of the limb supporting apparatus rather than the limb 50 itself. As a result, the wall 128 of the apparatus receives the majority of any localized pressure and distributes any transferred pressure over a side area of the arm so as to reduce the likelihood of a pressure injury.

In the illustrated embodiments, the arm 50 is restrained in the limb supporting apparatus by means of two broad straps 12. The straps 12 are broad to distribute pressure on the arm 50 should the arm unexpectedly move within the apparatus. In the illustrated embodiment, the width of the straps 12 is approximately two thirds the width of the base 4 of the apparatus. In further embodiments (not illustrated), the arm may be secured in the apparatus by means of a single strap or the apparatus does not use any restraints to secure the arm within the channel.

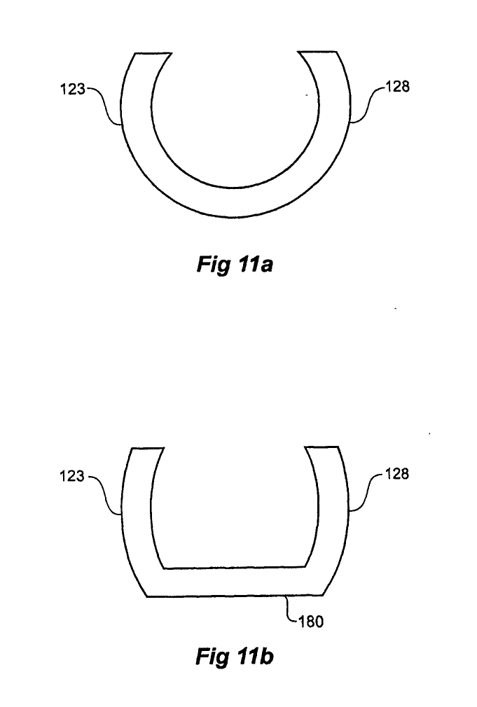

Referring now to FIG. 10, there is shown an arm protection apparatus comprising an elongate semi-encircling channel 100. The channel 100 comprises a base 180 and two side walls. The channel 100 is conformable to an arm. The channel 100 is made from a soft and flexible material such as but not limited to foam. The channel 100 conforms to the shape of a supported limb 50 to distribute pressure along the length of the limb. The base 180 of the channel 100 is flat, however, the semi-encircling channel 100 may be fashioned in other shapes such as but not limited to a channel having an arced base 180 such as that shown in FIG. 11a. The width of the channel 100 preferably corresponds to the width of a limb. In alternative embodiments (FIG. 11a and 11b), the elongate semi-encircling channel can be shaped to be a semi-circular containing two encircling walls 123 and 128 or, with curved walls 123 and 128 and a flat base 180.

The interior of the channel illustrated in FIG. 10 comprises a multitude of contours 105 formed on the interior of the base 180 and walls 123 and 128 of the channel 100 in an “egg shell” pattern. The contours 105 are equally distributed throughout the interior surface of the channel 100.

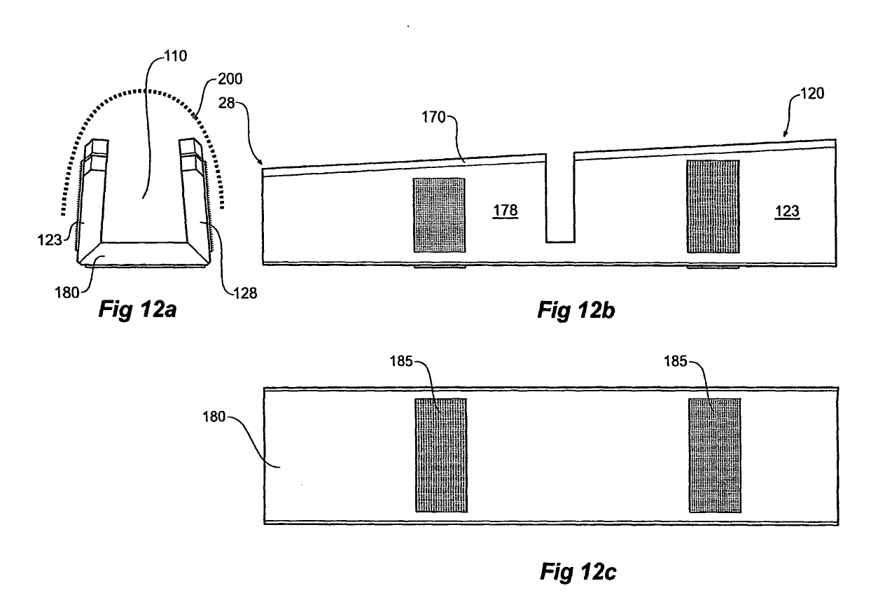

In FIG. 12a, the sides 123, 173, 128 and 178 of the channel 100 slope inwards to partially encircle a limb 50. The height of the sides are preferably greater than the depth of the limb 50 such that the apex of the sides are positioned above the limb. The sides of the channel 100 are preferably tapered such that the sides increase in height towards the proximal end of the channel 100 (FIG. 12b). This ensures that the proximal upper portion of a limb 50 is kept within the channel 100 since it is common that the thickness of a limb 50 is greatest nearest the body. In addition, a higher wall enables a limb 50 as well as peripheral medical equipment such as but not limited to blood pressure cuffs 70, to be contained within the elongate semi-encircling channel 100. The height of the channel 100 is sufficient to prevent the limb 50 from being easily dislodged from the channel.

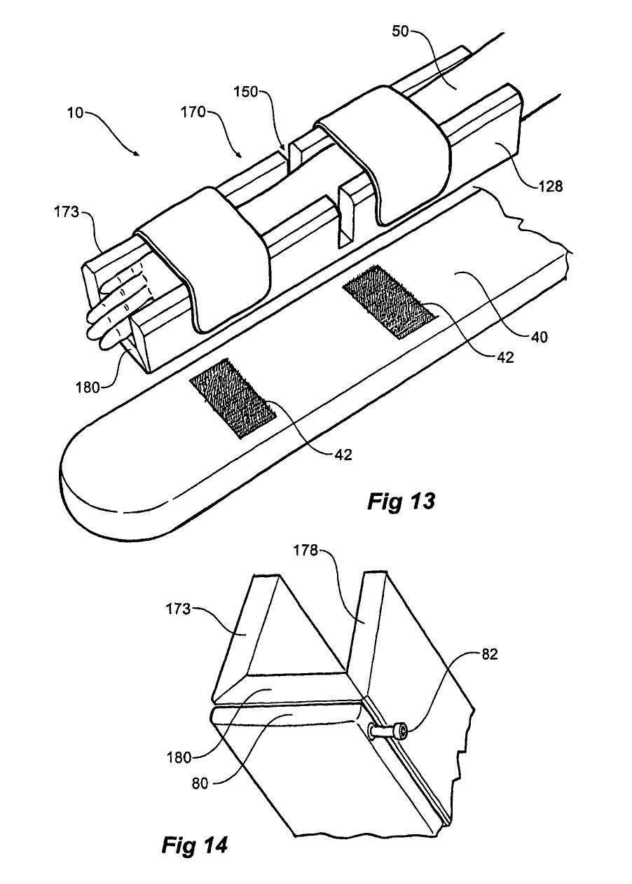

With the embodiments of the invention described thus far, they are generally connected to an arm board using straps (such as the straps 600 and 700 shown in FIGS. 2a or in FIG. 4). In some applications, it may be preferable to attach the apparatus to the arm board using Velcro only. This is illustrated in FIG. 13. Some arm boards have padding that is held in place with Velcro. With such arm boards, the padding can be removed to expose the Velcro as indicated in FIG. 13 so that the arm protection apparatus 10 can be attached direct to the arm board.

In another embodiment (not shown), the limb supporting apparatus may be enclosed in a disposable sleeve. Preferably the sleeve is resistant to body fluids and prevents the apparatus from coming into contact with body fluids.

FIG. 14 illustrates a further embodiment of the apparatus where the base 150 of the apparatus includes an inflatable element 80. In the illustrated embodiment, the inflatable element 80 is located adjacent the base 150 of the apparatus, the inflatable element 80 being connected to the base 150 and at the perimeter of the apparatus. In this embodiment, the inflatable element 80 can be inflated with air however it is also possible for the element 80 to be inflated by alternative gases or liquids. The inflatable element 80 enables the rigidity of the base 150 of the apparatus to be controlled to preferably offer a variable rigidity. It is preferable that the inflated base will stiffen the elongate channel to inhibit bending of the channel 100. It is thus possible that this apparatus could be used in limb injury, splinting and fracture transport applications. In alternate embodiments (not illustrated), the inflatable element 80 may be contained within the base 150 of the arm protecting apparatus.

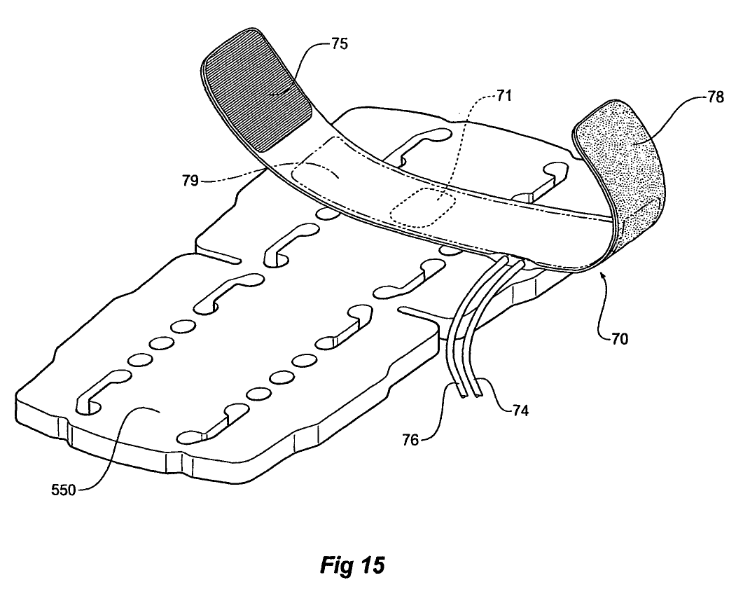

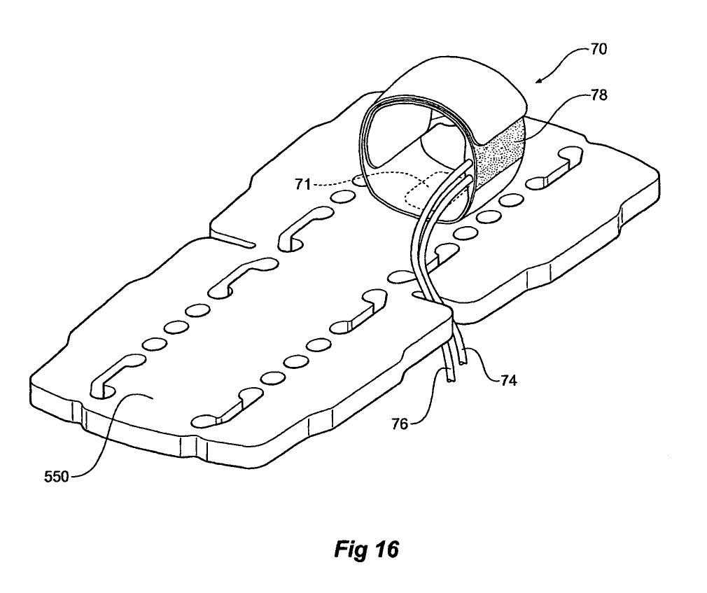

An eighth embodiment of the invention is illustrated in FIGS. 15 and 16. For this embodiment of the invention, a blood pressure cuff 70 having a Velcro pad 75 attachable to Velcro receiving loop material 78 is incorporated into the apparatus. Air inlet and exist stubs 74 and 76 are positioned so as to readily feed through the lateral slot as shown in FIG. 16. The blood pressure cuff 70 is attached to the foam using glue 71 as indicated in FIG. 15. In other embodiments attachment means other than glue, for instance, Velcro, can be used. The blood pressure cuff balloon 79 encircles the arm as is illustrated in FIG. 16. FIGS. 15 and 16 do not show the arm straps 200 and 300. However, in practice, arm straps are provided. In other embodiments of the invention (not shown) the blood pressure monitoring function may be provided by other elements incorporated into, or integral with, the channel 100. The blood pressure monitoring function can be incorporated to any of the other embodiments of the invention illustrated above.

Use of the various embodiments of the invention will now be described. With the embodiment of the invention illustrated in FIG. 4, the steps in first attaching the apparatus to an arm board and then safely securing and protecting an arm are illustrated progressively in FIGS. 5a to 5e.

FIG. 5a shows the apparatus sitting on a table for instance. From this position, the ends 620 and 720 of the first and second securing straps are removed such that the ends 620 and 720 dangle below the foam channel. The base 180 of the apparatus is then placed on an arm board 40 as is illustrated in FIG. 5b. Next the end 620 of the arm strap is looped up under the arm board 40 and attached to the upper arm strap 200 as is illustrated in FIG. 5c. The strap 200 is provided with loop material suitable for engagement by the Velcro pad 625 along its entire external surface. This provides flexibility as to the length of strap actually used to surround the arm board 40.

Turning now to FIG. 5d, the next step of use is shown in which the arm strap 200 is disconnected from the apparatus so as to allow an arm 50 to be seated within the open mouth of the channel 100 as is shown in FIG. 5e. The final step is securing the arm straps 200 and 300 over the arm as is shown in FIG. 5f. Again, because the securement straps 600 and 700 have a loop material as their external surface, the Velcro 225 and 325 can attach at any position on those straps. This provides great flexibility enabling the device to be used with patients having thin or thick arms for instance.

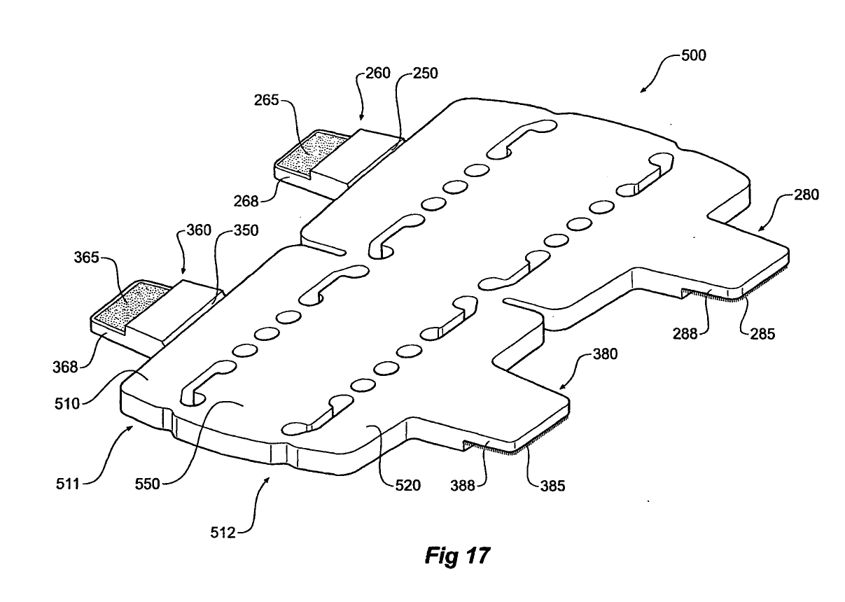

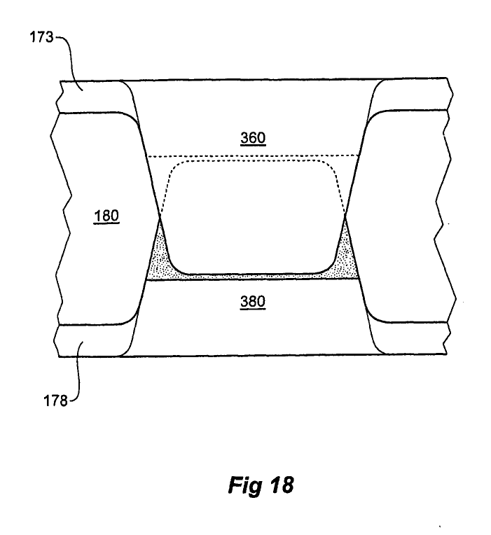

A ninth embodiment of the invention is shown in FIGS. 17 and 18. This embodiment of the invention is similar to that shown in FIG. 3a, but has the additional features of strap portions being integral with the foam sheet. More specifically, FIG. 17 shows a pliant foam sheet that is foldable to form an arm protection apparatus where the sheet includes an upper arm strap underlap portion 280 extending outwards from a first side portion 520 and an upper arm strap overlap portion 260 extending outwards from the second side portion 510. This embodiment of the invention is similar to that shown in FIG. 3a in that first and second fold zones 511 and 512 are provided to facilitate folding upwards of the first and second side portions 510 and 520 so as to form a channel for receiving and protecting a arm. Once the channel has been formed, the underlap and overlap portions 280 and 260 can be used to bridge the channel so as to encircle the arm. With the embodiment illustrated in FIG. 17, the underlap and overlap portions have ends that are adapted for releasable engagement with each other. Releasable engagement is provided by way of Velcro regions 265 and 285. These portions are recessed, although in other embodiments of the invention, non-recessed regions may be provided. The length of the recess regions may be varied to allow for a single sheet to be utilised with arms of varying sizes. V-shaped grooves 250 and 350 are provided to facilitate folding of the straps 200 and 300. For the strap portions 280 and 380 V-shaped grooves are not illustrated. This is to show that this feature is optional. In some embodiments of the invention, no fold zone will be provided, and in other embodiments of the invention, fold zones will be created through other means, for instance, through the use of holes.

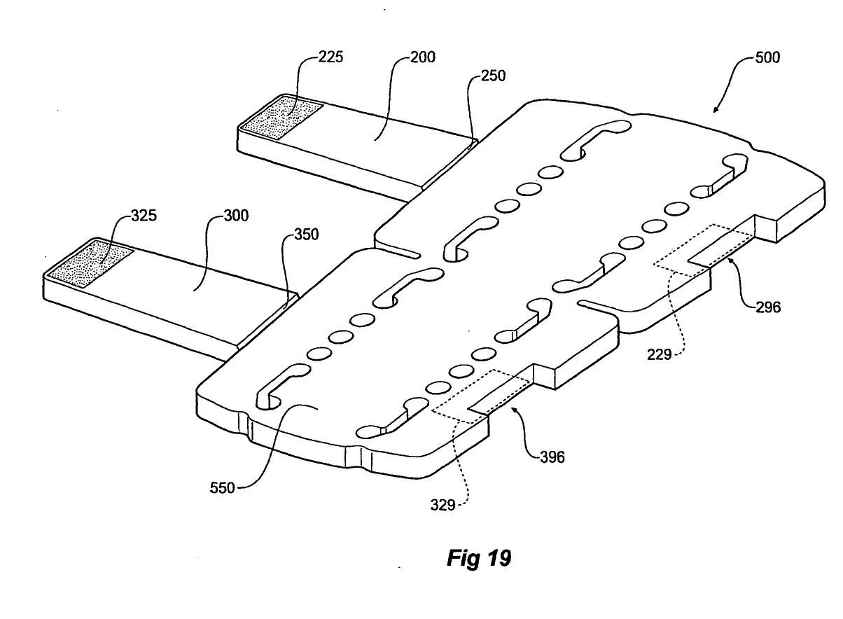

Turning now to FIG. 19, a tenth embodiment of the invention is shown. With the tenth embodiment of the invention, single piece straps 200 and 300 are provided. These straps are functionally similar to those provided in the embodiment of the invention illustrated in FIG. 2a, but are constructed integral with the foam sheet 500. V-shaped grooves 250 and 350 are provided to facilitate folding of the straps 200 and 300. Recesses 296 and 396 are provided to assist in locating the ends of the straps 200 and 300. Velcro hook and loop regions 225 and 229 for the upper arm strap and 325 and 229 for the lower arm strap are also provided.

The various embodiments of the invention described above can be used in many applications for protecting arms. For instance, the apparatus may be used in theatre either along side a patient's body as is illustrated in FIG. 9, attached to an arm board as illustrated in FIG. 8 or in pairs connected across a patient's back or front as described above. Any of the embodiments described above can be used while a patient is being transported. However, the embodiment illustrated in FIG. 6 will be most suitable for transport as it has a spine.

The present application claims priority from Australian Provisional Patent Application No. 2008905768 filed on 7 Nov. 2009. The entire contents of the aforementioned application is hereby incorporated by reference. It will be understood that the term “comprise” and any of its derivatives (eg. comprises, comprising) as used in this specification is to be taken to be inclusive of features to which it refers, and is not meant to exclude the presence of any additional features unless otherwise stated or implied.

Although illustrative embodiments of the present invention have been described in the foregoing detailed description, it will be understood that the invention is not limited to the embodiments disclosed, but is capable of numerous rearrangements, modifications and substitutions without departing from the scope of the invention as set forth and defined by the following claims.

1. An arm protection apparatus for protecting an arm, the apparatus including:
a channel formed from a pliant material and defining an upwardly opening mouth for receiving the arm, the channel having an upper arm receiving portion and a lower arm receiving portion;
an upper arm strap having a first end connected to a first side of the upper arm receiving portion and a second end adapted for releasable engagement with a second side of the upper arm receiving portion;
a lower arm strap having a first end connected to a first side of the lower arm receiving portion and a second end adapted for releasable engagement with a second side of the lower arm receiving portion, the upper and lower arm receiving portions partially separated by an upwardly opening lateral slot,
wherein, in use, the channel and the straps encircle the arm and the apparatus distributes pressure on immobilized tissue of the arm so as to reduce the likelihood of pressure injury.

2. The apparatus of claim 1 further including:
a first securing strap for securing the channel to an arm board, the first securing strap having a first end connected to the second side of the upper arm receiving portion and a second end adapted for releasable engagement with the first side of the upper arm receiving portion; and
a second securing strap for securing the channel to an arm board, the second securing strap having a first end connected to the second side of the lower arm receiving portion and a second end adapted for releasable engagement with the first side of the lower arm receiving portion.

3. The apparatus of claim 2 wherein the first end of the upper arm strap and the first end of the first securing strap are positioned opposite each other such that, when securing the channel to the arm board, the second end of the first securing strap releasable engages the upper arm strap at or near the upper arm strap's first end.

4. The apparatus of claim 1 wherein the pliant material is a single folded foam sheet including:
an elongate central base portion having a longitudinal axis, the base portion bounded by first and second fold zones extending generally parallel to the longitudinal axis;
a first side portion extending outwards from the first fold zone; and
a second side portion extending outwards from the second fold zone, whereby the first and second fold zones reduce the tendency of the first and second side portions to unfold.

5. The apparatus of claim 1 wherein at least one of the upper and lower arm straps are formed from and integral with the single folded foam sheet.

6. The apparatus of claim 1 wherein both of the upper and lower arm straps are formed from and integral with the single folded foam sheet.

7. An arm protection apparatus for protecting an arm, the apparatus including:
a channel formed from a pliant material and defining an upwardly opening mouth for receiving the arm, the channel having an upper arm receiving portion and a lower arm receiving portion;
an upper arm strap including an underlap portion extending from a first side of the upper arm receiving portion and an overlap portion extending from a second side of the upper arm receiving portion, the underlap and overlap portions having ends adapted for releasable engagement with each other;
an lower arm strap including an underlap portion extending from a first side of the lower arm receiving portion and an overlap portion extending from a second side of the lower arm receiving portion, the underlap and overlap portions having ends adapted for releasable engagement with each other,
wherein, in use, the channel and the straps encircle the arm and the apparatus distributes pressure on immobilised tissue of the arm so as to reduce the likelihood of pressure injury.

8. An arm protection apparatus for protecting an arm, the apparatus including:
a channel formed from a pliant material and defining an upwardly opening mouth for receiving the arm, the channel having an upper arm receiving portion and a lower arm receiving portion;
an upper arm strap having a first end connected to a first side of the upper arm receiving portion and a second end adapted for releasable engagement with a second side of the of the upper arm receiving portion;
a lower arm strap having a first end connected to a first side of the lower arm receiving portion and a second end adapted for releasable engagement with a second side of the of the lower arm receiving portion,
wherein the pliant material is a single folded foam sheet including:
an elongate central base portion having a longitudinal axis, the base portion bounded by first and second fold zones extending generally parallel to the longitudinal axis;
a first side portion extending outwards from the first fold zone; and
a second side portion extending outwards from the second fold zone,
whereby the first and second fold zones reduce the tendency of the first and second side portions to unfold.

9. A foam sheet foldable to form an arm protection apparatus, the sheet including:
an elongate central base portion having a longitudinal axis, the base portion bounded by first and second fold zones extending generally parallel to the longitudinal axis;
a first side portion extending outwards from the first fold zone; and
a second side portion extending outwards from the second fold zone,
wherein the first and second fold zones facilitate folding upwards of the first and second side portions so as to form a channel for receiving and protecting an arm.

10. The foam sheet of claim 9 wherein the first and second fold zones are formed by a plurality of holes arranged in respective first and second lines.

11. The foam sheet of claim 9 wherein the first side portion includes an upper arm engaging portion and a lower arm engaging portion, the upper and lower arm engaging portions partially separated by a laterally opening slot.

12. The foam sheet of claim 9 further comprising at least one of an upper and a lower arm strap formed from and integral with the foam sheet.

13. The foam sheet of claim 12 comprising the upper and the lower arm straps, and wherein both of the upper and lower arm straps are formed from and integral with the foam sheet.

14. A pliant sheet foldable to form an arm protection apparatus, the sheet including:
an elongate central base portion having a longitudinal axis, the base portion bounded by first and second fold zones extending generally parallel to the longitudinal axis;
a first side portion extending outwards from the first fold zone;
a second side portion extending outwards from the second fold zone, wherein the first and second fold zones facilitate folding upwards of the first and second side portions so as to form a channel for receiving and protecting an arm;
an arm strap underlap portion extending outwards from the first side portion; and
an arm strap overlap portion extending outwards from the second side portion,
wherein the first and second fold zones facilitate folding upwards of the first and second side portions so as to form a channel for receiving and protecting an arm and wherein the underlap and overlap portions are adapted to bridge the channel so as to encircle an arm.

15. The sheet of claim 14 wherein the underlap and overlap portions have ends adapted for releasable engagement with each other.

16. An arm protection apparatus for protecting an arm, the apparatus including:
a channel formed from a pliant material and defining an upwardly opening mouth above a base for receiving the arm, the channel having an upper arm receiving portion and a lower arm receiving portion;
an upper arm strap having a first end connected to a first side of the upper arm receiving portion and a second end adapted for releasable engagement with a second side of the of the upper arm receiving portion;
a lower arm strap having a first end connected to a first side of the lower arm receiving portion and a second end adapted for releasable engagement with a second side of the of the lower arm receiving portion; and
a spine under the base of the channel, the spine having a hinge between the upper arm receiving portion and the lower arm receiving portion,
wherein, in use, the channel and the straps encircle the arm and the apparatus distributes pressure on immobilized tissue of the arm so as to reduce the likelihood of pressure injury.

17. The apparatus of claim 16 wherein the spine includes a lock, the lock movable between an unlocked position in which the channel is foldable about a fold axis between the upper arm receiving portion and the lower arm receiving portion and an locked position in which the channel is locked against folding about a fold axis between the upper arm receiving portion and the lower arm receiving portion.

18. The apparatus of claim 17 wherein the lock includes a sleeve, the sleeve slidable over the hinge so as to prevent operation of the hinge.

19. An arm protection apparatus for protecting an arm, the apparatus including:
a channel formed from a pliant material and defining an upwardly opening mouth above a base for receiving the arm, the channel having an upper arm receiving portion and a lower arm receiving portion;
an upper arm strap having a first end connected to a first side of the upper arm receiving portion and a second end adapted for releasable engagement with a second side of the of the upper arm receiving portion;
a lower arm strap having a first end connected to a first side of the lower arm receiving portion and a second end adapted for releasable engagement with a second side of the of the lower arm receiving portion; and
an inflatable element, the element located adjacent to the base of the channel,
whereby inflation of the inflatable element stiffens the channel against bending.

20. A method of protecting and restraining an arm during a medical procedure, the method including the steps of:
positioning the patient on an operating table;
positioning an arm of the patient into an arm protecting apparatus having an upwardly opening slot within a side wall of the apparatus for allowing easy access to the arm, the apparatus partly-encircling the arm along a substantial length of both a forearm portion of the arm and a humeral portion of the arm;
securing the forearm and upper arm portions using at least two straps, each strap bridging walls of the limb support apparatus so as to encircle the arm;
whereby the arm is restrained from substantial movement during the procedure and is protected from lateral impacts.

21. A method of protecting and restraining an arm during a medical procedure using the apparatus of claim 2, the method including the steps of:
positioning the apparatus onto an arm board of an operating table;
arranging the first strap so that it extends from the second side of the upper arm receiving portion, under the arm board and up to the upper arm strap;
adhering the second end of the first securing strap to the upper arm strap;
arranging the second strap so that it extends from the second side of the lower arm receiving portion, under the arm board and up to the lower arm strap;
adhering the second end of the second securing strap to the lower arm strap;
positioning the patient on an operating table;
positioning an arm of the patient into the channel of the apparatus;
looping the upper arm strap from the first side of the upper arm receiving portion over the arm to the second side of the upper arm receiving portion;
adhering the second end of the upper arm strap to the first end of the first securing strap;
looping the lower arm strap from the first side of the lower arm receiving portion over the arm to the second side of the lower arm receiving portion;
adhering the second end of the lower arm strap to the first end of the second securing strap,
whereby the arm is restrained from substantial movement during the procedure and is protected from lateral impacts.
